(19) United States
(12) Patent Application Publication
(10) Pub. No.: US 2026/0234505 A1
(43) Pub. Date: Aug. 13, 2026

(54) Candle Wick Tool with Flexible Rack Drive

(71) Applicant: Aaron James Jesse, Oroville, CA (US)

(72) Inventor: Aaron James Jesse, Oroville, CA (US)

(21) Appl. No.: 19/646,471

(22) Filed: Apr. 13, 2026

Related U.S. Application Data
(63) Continuation-in-part of application No. 18/142,617, filed on May 3, 2023.

(51) Int. Cl. C11C 5/02

(52) U.S. Cl. CPC C11C 5/02

(57) ABSTRACT

A candle wick tool comprising a central column housing a biased wick application plunger and telescopic legs mounted about the column. Each leg terminates in a contact foot that engages the transition between the bottom surface and sidewall of a vessel. Flexible racks actuate the legs, each attached to a timing rack collar encircling the column and to the innermost section of a telescopic leg. A bevel gear and spline shaft assembly synchronizes the flexible racks, ensuring equal travel distance for all legs. The flexible racks follow nonlinear trajectories along the column, transmitting forces through toothed engagement with the bevel gear shafts. Alternatively, a roller chain and cog system replaces the flexible racks. A handle on the timing rack collar retracts the legs for vessel insertion; upon release, the legs deploy until the contact feet engage the vessel, and the plunger bonds the wick assembly to the vessel floor.

### CROSS-REFERENCE TO RELATED APPLICATIONS

This application is a continuation-in-part of U.S. Utility patent application Ser. No. 18/142,617, entitled “Candle Wick Centering Tool,” filed May 3, 2023. This application is also related to U.S. patent application Ser. No. 19/542,550, entitled “Candle Wick Centering Tool,” filed Feb. 17, 2026. The entire contents of both applications are incorporated herein by reference. All embodiments, variations, features, and advantages disclosed in those applications remain fully applicable to the present application.

### TECHNICAL FIELD

This application relates in general to an article of manufacture for setting a candle wick assembly in a vessel using telescopic legs.

### BACKGROUND

Candle making is becoming an increasingly popular hobby and a worldwide industry of manufacture. According to grandviewresearch.com, in 2024 the global candle industry was valued at $14.06 billion, and by 2030 is projected to grow to $20.10 billion. The process of assembling a container candle is simple. Placing a wick assembly in a container is an unavoidable step in most container candle processes, hobby or manufacturing. The traditional method of placing candle wicks in vessels by hand is simply to press an adhesive wick assembly into the center of the bottom of a vessel as best a person can. If a candle wick is not placed in the center of the vessel, it causes uneven melting of the wax and heat distribution that can lead to fire hazard. The taller vessels can prove more difficult to set wicks in, limiting some candle makers. There have been several attempts to fill the need for a wick centering tool. The novel approach this invention takes will give home candle makers and manufacturing facilities a faster, easier, more accurate way to set candle wicks by hand and machine power, improving production, product quality, and safety when the candle is used. The tool will make setting candle wicks in vessels much easier, faster, and improve the safety of the end product.

Prior approaches to wick centering have utilized fixed graduated steps that rest on the vessel rim. The present invention provides an alternative, the flexible rack and bevel gear system that offers unique advantages in motion transfer along nonlinear paths while maintaining mechanical synchronization of telescopic appendages. The flexible rack concept evolved from roller chain and cog drive systems, adapting the toothed engagement principle into a semi-rigid member capable of transmitting both push and pull forces along curved trajectories.

### SUMMARY

In accordance with the present invention, the above and other problems are solved by providing an article of manufacture for a candle wick centering tool employing a flexible rack drive mechanism according to the examples, principles, and embodiments disclosed herein.

The tool comprises a central column housing a wick application plunger biased toward the upper retracted position. A plurality of telescopic legs are mounted about the periphery of the central column and extend outwardly and downwardly, each ending in a contact foot configured to engage the transition between the bottom surface and sidewall of a vessel, the telescopic legs are biased toward the outermost position. A flexible rack is attached at its upper end to a timing rack collar that encircles the central column, and at its lower end to the innermost section of a telescopic leg. Each telescopic leg comprises an outermost section fixed to the central column and progressively smaller nested sections, with all sections except the outermost retracting into the outermost section when the flexible rack draws the innermost section inward. Movement of the timing rack collar, controlled by a handle, draws the flexible racks upward or allows them downward, thereby retracting or deploying all sections of the telescopic legs. The flexible racks are synchronized by a bevel gear and spline shaft assembly that ensures equal travel distance for all legs, mechanically maintaining a centered position relative to the central column.

In an alternative embodiment, a roller chain and cog system replaces the flexible rack. The roller chain engages cog wheels mounted on the bevel gear shafts, providing synchronized retraction and extension of the telescopic legs enabling the legs to be actively driven outward as well as retracted inward.

Once the legs are deployed and the contact feet engage the vessel bottom-sidewall transition, the wick application plunger is depressed to bond the wick assembly to the vessel floor via an adhesive tab. The tool is then removed, leaving the wick assembly precisely centered within the vessel.

### BRIEF DESCRIPTION OF THE DRAWINGS

It is to be understood that no part of the example art is to scale. Referring now to the drawings in which like reference numbers represent corresponding parts throughout:

FIG. 1 illustrates a view of the principal embodiment of the candle wick centering tool with flexible rack drive and telescopic legs in the deployed configuration, showing push handle 120, wick application plunger 101, central column 102, slide handle collar 103, stop 113, timing rack collar 106, handle 107, flexible racks 108, spline shaft 109, bevel gear 110, mounting brackets 111, telescopic legs 104, innermost telescopic section 112, and contact feet 105.

FIG. 2 illustrates a detail side profile view of the timing rack collar 106, handle 107, flexible rack 108, and bevel gear 110 assembly, showing the nonlinear path of the flexible rack as it transitions from the central column downward through the bevel gear and outward toward the telescopic leg. FIG. 3 illustrates a top-down detail view of the bevel gear 110 and spline shaft 109 assembly, showing the arrangement of bevel gears and spline shafts secured to the central column 102 via mounting brackets 111, and their engagement with the flexible racks. FIG. 4 illustrates a wick assembly with labeled components, provided to aid understanding of the candle wick centering tool and its interaction with the wick assembly.

### DETAILED DESCRIPTION

This application relates generally to an article of manufacture for providing a candle wick assembly centering and setting device, and more particularly to embodiments employing a flexible rack drive mechanism for synchronized control of telescopic legs.

Various embodiments of the present invention will be described in detail with reference to the drawings, wherein reference numbers represent parts and assemblies throughout. The following description recites various aspects and embodiments of the inventions disclosed herein. No particular embodiment is intended to define the nature and scope of the invention. Rather, the provided embodiments are non-limiting, reference examples. Additionally, examples set forth in these specificalities are not intended to be limiting and merely set forth some of the many possible embodiments of the claimed novel invention.

The singular forms “a,” “an” and “the” include plural referents, unless context clearly dictates otherwise.

It should be understood that the terms “comprises,” “comprising,” “includes,” and “including” specify the presence of stated features, steps, or components, but do not preclude the presence of addition of one or more other features, steps, or components. It should also be appreciated by those skilled in the art that in different embodiments, some functions or acts may take place out of order.

Furthermore, the terms “individual,” “user” and “operator” refer to an entity, artificial or human, using the candle wick centering tool.

The term “invention,” “present invention,” “embodiment,” or “tool” refers to the disclosed invention being applied for via the patent application with the title “Candle Wick Tool with Flexible Rack Drive.”

Within this disclosure, the terms “wick application plunger,” “wick plunger,” “application plunger,” and “plunger” may be used interchangeably to refer to the central shaft that holds and deploys the wick assembly.

The wick assembly, illustrated in FIG. 4, comprises: the candle wick itself (401); a wick tab mechanically connected to one end of the wick (402); a neck (403), which is a hollow cylindrical protrusion extending from one side of the wick tab and configured to accept and secure the wick via mechanical connection; and an adhesive layer (404) bonded to the tab opposite the wick and neck. This adhesive layer bonds the wick assembly to the vessel floor. This combination of components may be referred to as the “wick,” “wick assembly,” or “adhesive wick assembly.” It is understood that the wick components are pre-assembled prior to use with the tool.

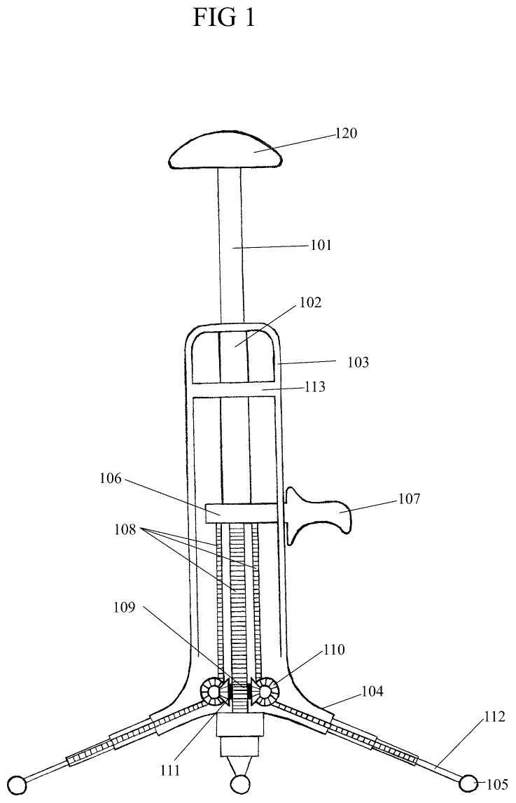

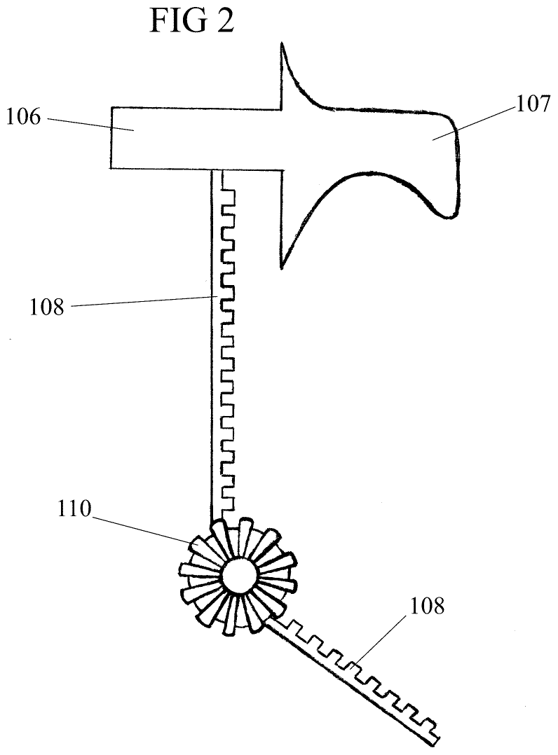

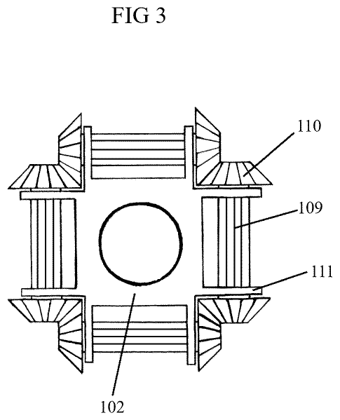

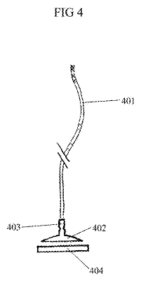

In the principal embodiment, illustrated in FIG. 1, the tool comprises a central column 102 within which houses and guides a wick application plunger 101. A biasing mechanism, such as a coil spring or other means of stored energy, retains the plunger 101 in its uppermost retracted position until use. The plunger 101 extends beyond the central column 102 at both ends, with a push handle 120 at the top end and a wick receiver at the bottom end. The wick receiver retains a prefabricated adhesive wick assembly via elastic, magnetic, or mechanical force until deployment. A stop 113 is positioned on the central column 102 and serves as a mechanical limit to prevent over-collapse of the telescopic legs during retraction. The stop 113 also functions as a midway structural support for the central column 102, reinforcing rigidity along its length.

A timing rack collar 106 encircles the central column 102 and is free to slide along the longitudinal axis of the column. A handle 107 is attached to the timing rack collar 106 to facilitate manual operation. The timing rack collar 106 serves as both a mounting point for the upper ends of the flexible racks and as a synchronization guide that ensures uniform upward or downward movement of all flexible racks simultaneously.

A plurality of flexible racks 108 are arrayed around the central column 102, each corresponding to one telescopic leg 104. Each flexible rack 108 is a semi-rigid toothed member capable of following a curved or contoured path while maintaining toothed engagement with a spline shaft 109. The upper end of each flexible rack 108 is secured to the timing rack collar 106. From this connection point, each flexible rack 108 travels downward along the exterior of the central column 102 until it reaches a bevel gear 110 and spline shaft 109 assembly.

The bevel gear 110 and spline shaft 109 assembly is mounted to the central column 102 via mounting brackets 111 that permit each shaft to rotate smoothly about its longitudinal axis. At the point of engagement between the flexible rack 108 and the toothed spline shaft 109, rotational input from the bevel gear 110 is redirected via the spline shaft 109, prompting the rack to shift direction and route outward toward the inner portion of the telescopic leg 104. This change in trajectory allows the rack to transmit motion efficiently around a structural corner, facilitating actuation of the telescopic leg through synchronized gear and rack engagement. The flexible nature of rack 108 accommodates this directional transition while maintaining mechanical integrity under load.

The lower end of each flexible rack 108 is attached to the innermost section 112 of a telescopic leg 104. Each telescopic leg 104 comprises an outermost section fixed to the central column and a series of progressively smaller nested sections that slide within the outermost section. The innermost section 112 carries the contact foot 105 at its distal end. The contact foot 105 is contoured to engage the transition between the bottom surface and sidewall of a vessel. When the flexible rack 108 draws the innermost section 112 inward, all intermediate sections retract in sequence into the outermost fixed section, collapsing the leg. When the flexible rack is released, all sections telescope outward in sequence toward the outermost position under elastic bias until the contact foot 105 engages the vessel.

In operation, the user loads a prefabricated adhesive wick assembly into the wick receiver at the bottom end of the plunger 101. The user then pulls upward on handle 107, which raises the timing rack collar 106. This upward movement draws all flexible racks 108 upward in synchronized motion, enforced by both the timing rack collar 106 and the bevel gear 110 and spline shaft 109 assembly. With the legs retracted, the tool can be inserted into a vessel with the contact feet 105 oriented toward the base.

When the handle 107 is released, the telescopic legs 104 telescope toward the outermost position under elastic bias until the contact feet 105 engage the transition between the vessel bottom and sidewall. The equal travel distance maintained by the synchronized flexible rack and bevel gear system ensures that all legs extend equally, automatically centering the central column 102—and thus the wick application plunger 101—within the vessel.

The user then presses down on the push handle 120 at the top of the plunger 101, overcoming the plunger biasing mechanism and advancing the plunger downward until the adhesive wick assembly contacts the vessel floor. The adhesive bonds the wick assembly to the center of the vessel bottom. The plunger is then allowed to return to its uppermost position under elastic force, the handle 107 is pulled upward to retract the legs, and the tool is removed, leaving the wick assembly adhered precisely at the geometric center of the vessel.

The flexible rack 108 is distinguished from conventional rigid rack-and-pinion systems in that the flexible rack can follow nonlinear trajectories. This allows the rack to travel downward along the central column and then redirect outward toward the leg without requiring intermediate linkages, bell cranks, or universal joints. The toothed engagement between the flexible rack and the bevel gear shaft ensures positive drive in both directions—enabling both active retraction (pull) and active deployment (push) of the telescopic legs.

In an alternative embodiment, a roller chain and cog system is employed in place of the flexible racks 108. In this configuration, cog wheels are mounted on the bevel gear shafts 109 and engage a roller chain that follows a path analogous to the flexible rack path described above. The upper end of each roller chain is attached to the timing rack collar 106, and the lower end is attached to the innermost section 112 of a telescopic leg 104.

The roller chain and cog embodiment provides synchronized leg retraction through the same bevel gear and timing collar system described above. The cog wheels on the bevel gear shafts ensure that all chains move in unison, maintaining equal travel distance for each leg. The roller chain is the conceptual predecessor of the flexible rack—the flexible rack evolved from the roller chain concept.

In operation, the roller chain and cog embodiment functions identically to the flexible rack embodiment in terms of the overall centering and wick placement sequence: load the wick assembly, pull the handle to retract the legs, insert the tool into the vessel, release the handle to deploy the legs, press the plunger to bond the wick, retract the legs, and remove the tool.

The Candle Wick Tool with Flexible Rack Drive may have any number of telescopic legs in any embodiment, provided the legs are equally spaced around the central column to ensure uniform centering force.

An outer body or casing surrounding the timing rack, bevel gear, and spline shaft components, providing protection for both the mechanical elements and the user. The casing shields internal components from impact, debris, and environmental exposure while mitigating pinch points and mechanical hazards during operation.

The Tool may include a locking mechanism, such as but not limited to a cam lock, wedge lock, or other suitable device, configured to secure the timing rack collar and thereby the legs in a fixed position for plunger deployment and or use with vessels of consistent circumference.

The wick application plunger may include a retention mechanism configured to temporarily secure the wick assembly prior to deployment. This mechanism may comprise a spring clamp, mechanical clamp, elastic friction ring, magnetic element, or other suitable structure positioned at the distal end of the plunger to grip the wick tab during insertion and release it upon actuation.

It is intended that the tool may be operated by a human, robotic system, or other entity with minimal modification.

The foregoing embodiments are presented by way of example only and do not limit the scope of the invention. Numerous combinations and variations of features and embodiments have not been specifically illustrated or described herein, but remain within the spirit and scope of the Candle Wick Tool with Flexible Rack Drive.

Unless specifically described, no action, component, material, or feature will be constituted as critical or vital to the invention described.

What is claimed is:

1. A tool for placing a candle wick assembly in the center of the bottom of a vessel, comprising:
a central column;
a wick application plunger extending longitudinally through the central column and biased toward a retracted position by a biasing mechanism, the wick application plunger configured to secure a candle wick assembly at its distal end;
a plurality of telescopic legs mounted about the periphery of the central column, each telescopic leg comprising an outermost section fixed to the central column and a series of progressively smaller nested sections that slide within the outermost section, the innermost section carrying a contact foot at its distal end configured to engage the transition between a bottom surface and a sidewall of the vessel, wherein all sections except the outermost retract into the outermost section when the leg is collapsed;
a timing rack collar encircling the central column and slidable along a longitudinal axis thereof;
a plurality of flexible racks, each flexible rack being a semi-rigid toothed member attached at an upper end to the timing rack collar and at a lower end to an innermost section of a corresponding telescopic leg, each flexible rack following a nonlinear path along the central column and through a bevel gear and spline shaft assembly mounted to the central column;
wherein movement of the timing rack collar draws the flexible racks to retract the telescopic legs, and release of the timing rack collar allows the telescopic legs to telescope toward the outermost position until the contact feet engage the transition between the bottom surface and sidewall of the vessel, thereby centering the central column and the wick application plunger within the vessel; and
wherein the wick application plunger is actuated to deploy the candle wick assembly at the center of the vessel bottom.

2. The tool of claim 1, wherein the bevel gear and spline shaft assembly comprises a plurality of bevel gears and corresponding spline shafts mounted to the central column via mounting brackets, the spline shafts configured to rotate about their longitudinal axes and redirect each flexible rack from a path along the central column to a path extending outward toward the corresponding telescopic leg.

3. The tool of claim 1, wherein the flexible racks transmit both push and pull forces through toothed engagement with the bevel gear and spline shaft assembly, enabling both active retraction and active deployment of the telescopic legs.

4. The tool of claim 1, wherein the timing rack collar serves as a synchronization guide that ensures uniform movement of all flexible racks simultaneously.

5. The tool of claim 1, further comprising a handle attached to the timing rack collar to facilitate manual retraction of the telescopic legs.

6. The tool of claim 1, wherein the telescopic legs are biased toward the outermost position by an elastic biasing element.

7. The tool of claim 1, further comprising an outer casing surrounding the bevel gear and spline shaft assembly and the timing rack collar, the outer casing configured to shield mechanical components from damage and to protect the user from pinch points during operation.

8. The tool of claim 1, further comprising a locking mechanism configured to secure the timing rack collar in a fixed position along the central column, thereby fixing the telescopic legs at a predetermined extension for use with vessels of consistent circumference.

9. The tool of claim 1, wherein the wick application plunger includes a retention mechanism at its distal end configured to temporarily secure the candle wick assembly prior to deployment, the retention mechanism selected from the group consisting of a spring clamp, a mechanical clamp, an elastic friction ring, and a magnetic element.

10. The tool of claim 1, wherein the contact feet are contoured to seat against the junction where a substantially flat bottom surface meets a substantially vertical sidewall of the vessel.

11. A tool for placing a candle wick assembly in the center of the bottom of a vessel, comprising:
a central column;
a wick application plunger extending longitudinally through the central column and biased toward a retracted position by a biasing mechanism, the wick application plunger configured to secure a candle wick assembly at its distal end;
a plurality of telescopic legs mounted about the periphery of the central column, each telescopic leg comprising an outermost section fixed to the central column and a series of progressively smaller nested sections that slide within the outermost section, the innermost section carrying a contact foot at its distal end configured to engage the transition between a bottom surface and a sidewall of the vessel, wherein all sections except the outermost retract into the outermost section when the leg is collapsed;
a timing rack collar encircling the central column and slidable along a longitudinal axis thereof;
a plurality of roller chains, each roller chain attached at an upper end to the timing rack collar and at a lower end to an innermost section of a corresponding telescopic leg, each roller chain engaging a cog wheel mounted on a bevel gear shaft of a bevel gear assembly mounted to the central column;
wherein movement of the timing rack collar draws the roller chains to retract the telescopic legs, and release of the timing rack collar allows the telescopic legs to telescope toward the outermost position until the contact feet engage the transition between the bottom surface and sidewall of the vessel, thereby centering the central column and the wick application plunger within the vessel; and
wherein the wick application plunger is actuated to deploy the candle wick assembly at the center of the vessel bottom.

12. The tool of claim 11, wherein the cog wheels on the bevel gear shafts ensure synchronized movement of all roller chains, maintaining equal travel distance for each telescopic leg.

13. The tool of claim 11, further comprising a handle attached to the timing rack collar to facilitate manual retraction of the telescopic legs.

14. The tool of claim 11, wherein the contact feet are contoured to seat against the junction where a substantially flat bottom surface meets a substantially vertical sidewall of the vessel.

15. The tool of claim 11, wherein the telescopic legs are biased toward the outermost position by an elastic biasing element.

16. A method for centering and placing a candle wick assembly at the center of the bottom of a vessel using a tool having a central column, a wick application plunger, a plurality of telescopic legs, and a plurality of flexible racks synchronized by a bevel gear and spline shaft assembly, the method comprising:
loading a prefabricated adhesive wick assembly into a wick receiver at a distal end of the wick application plunger;
pulling a handle attached to a timing rack collar to draw the flexible racks upward in synchronized motion, thereby retracting the telescopic legs inward;
inserting the tool into the vessel with the contact feet oriented toward the base of the vessel;
releasing the handle to allow the telescopic legs to telescope toward the outermost position under elastic bias until the contact feet engage the transition between the bottom surface and sidewall of the vessel, thereby centering the wick application plunger within the vessel;
depressing the wick application plunger to advance the adhesive wick assembly to the vessel floor and bond the wick assembly to the center of the vessel bottom; and
retracting the telescopic legs and removing the tool from the vessel, leaving the wick assembly adhered at the geometric center of the vessel bottom.

17. The tool of claim 11, further comprising a locking mechanism configured to secure the timing rack collar in a fixed position along the central column, thereby fixing the telescopic legs at a predetermined extension for use with vessels of consistent circumference.
